(19) United States
(12) Patent Application Publication
(10) Pub. No.: US 2012/0099244 A1
(43) Pub. Date: Apr. 26, 2012

(54) ELECTRODE OF HIGH-DENSITY SUPER CAPACITOR AND METHOD FOR MANUFACTURING SAME

(75) Inventors: Byung Jun Lee, Seoul (KR); Byeong Sun Lee, Seoul (KR); Tae Gyun Kim, Gimpo-si (KR); Jung Ae Kim, Seoul (KR); Byoung Kyu Kim, Seoul (KR)

(73) Assignee: AMOGREENTECH CO., LTD., Kimpo-si (KR)

(21) Appl. No.: 13/379,239

(22) PCT Filed: Jul. 2, 2009
(86) PCT No.: PCT/KR09/03632

§ 371 Date: Dec. 19, 2011

(30) Foreign Application Priority Data
Jun. 19, 2009 (KR) 10-2009-0054849

(51) Int. Cl. H01G 9/04; B05D 5/12; B82Y 30/00

(52) U.S. Cl. 361/502; 427/79; 977/788

(57) ABSTRACT

Provided is a supercapacitor electrode that is coupled on one side or both sides of a collector, in which the supercapacitor electrode consists of a carbon material that forms an electric double layer, in which the carbon material consists of: a powder-shaped electrode active material; a powder-shaped conductive material; and a fibrous carbon material of a aspect ratio of 3-33. The supercapacitor electrode can be implemented into a high-capacitance or high-power supercapacitor together with low equivalent series resistance.

### TECHNICAL FIELD

The present invention relates to a high-density supercapacitor electrode and its manufacturing method, and more particularly to a high-density supercapacitor electrode and its manufacturing method that uses a mixture of carbon materials whose size and shape differ from each other to thereby increase an electrode filling density and to thus secure high capacitance or high power together with low equivalent series resistance (ESR).

### BACKGROUND ART

In general, supercapacitors use electrostatic characteristics but batteries use electrochemical reaction. Accordingly, the number of times for charging and discharging supercapacitors is almost infinite when compared to those of batteries, to thereby enable the supercapacitors to be used semi-permanently. In addition, supercapacitors have a very fast energy charging and discharging speed, respectively, to thereby show a power density that is several tens of times larger than that of each battery.

Therefore, applications of supercapacitors are now being gradually expanded over industrial fields due to the supercapacitor's features that cannot be obtained by conventional chemical-cell batteries. In particular, at the times of today's high oil prices, effectiveness of supercapacitors as energy buffers is gradually increasing in the field of developing next-generation environmentally friendly vehicles such as Electric Vehicles (EV), Hybrid Electric Vehicles (HEV) or Fuel Cell Vehicles (FCV).

That is, supercapacitors are being used in combination with chemical-cell batteries as an auxiliary energy storage device, in which the supercapacitors take charge of an instantaneous vehicle energy supply and absorption, and the chemical-cell batteries take charge of an average vehicle energy supply, to thus expect to obtain effects of improving efficiency of an overall vehicle system and extending lifespan of an energy storage system.

In addition, supercapacitors can be used as secondary power supply devices in portable electronic products such as mobile phones and video recorders, and their importance and usage are gradually increasing.

The supercapacitors are largely classified into Electric double layer Capacitors (hereinafter referred to as EDLC capacitors) and oxidation and reduction capacitors (hereinafter referred to as pseudo capacitors).

The EDLC capacitor accumulates charges by an electric double layer created on the surface of the EDLC capacitor, while the pseudo capacitor accumulates charges by an oxidation reduction reaction of metal oxide that can be used as an active material.

First, the pseudo capacitor has problems that the price of a metal oxide material (in particular, ruthenium oxide) is expensive, and that the material is environmentally friendly at the time of disposal after use, to thereby cause environmental pollution.

On the contrary, the EDLC capacitor is made of an eco-friendly carbon material together with excellent stability of an electrode material itself As the carbon electrode material are used carbon nanofiber (CNF) and activated carbon nanofiber (ACNF) that are manufactured by carbonization of polymers such as activated carbon powder (ACP), carbon nanotube (CNT), graphite, vapor grown carbon fiber (VGCF), and carbon aerogel, polyacrylonitrile (PAN) and polyvinylidenefluoride (PVdF). Carbon black (CB) may be added in the EDLC capacitor in addition to the carbon material.

The EDLC capacitor is composed of a current collector, two electrodes, an electrolyte and a separator. Due to the separator, the electrolyte is filled between the two electrodes that are electrically separated from each other. The current collector plays a role of charging or discharging electric charges in the electrodes effectively. The electrodes that are made of activated carbon that is used as an electrode material for the EDLC capacitor are porous having pores and have a wide specific surface area. If the two electrodes are electrically charged, positive (+) ions dissociated from the electrolyte enter pores of the negatively charged activated carbon electrode, to thus form a positive (+) layer. The positive (+) layer forms an electric double layer together with a negative (−) layer that is formed on an interface of the activated carbon electrode. Accordingly, electric charges are charged between the two electrodes.

The capacitance of the EDLC capacitor is highly dependent on structure and physical properties of the activated carbon electrodes, which requires the following characteristics: a large specific surface area, have a small inherent internal resistance of a material, and a high density of a carbon material, and so forth.

For example, in the case of the electrodes of the EDLC capacitor, the polyacrylonitrile (PAN) is base-activated to thereby obtain activated carbon nanofiber (ACNF) having a high specific surface area of 1500-3000 m²/g or so. However, because of a low density of the activated carbon nanofiber (ACNF), equivalent series resistance (ESR) becomes more or less higher, capacitance between the electrodes of the EDLC capacitor is lower than that between electrodes of an EDLC capacitor made of active carbon powder (ACP). As described above, if the density of the electrode active material is low, resistance generally becomes larger and capacitance is reduced.

As described above, density and resistance of electrodes made of an active material and a conductive material in an EDLC capacitor, and capacitance of the EDLC capacitor have a close relationship with each other.

Specifically, if a content of the conductive material increases, resistance of the electrodes will be reduced due to a high electrical conductivity of the conductive material. However, when the conductive material is compared with an active material such as activated carbon, the former has a lower specific surface area than that of the latter. Accordingly, capacitance of the EDLC capacitor is also reduced. In addition, if a content of an active material with a high density increases, capacitance increases. However, because the electrical conductivity of the active material is not high like that of the conductive material, resistance also tends to increase.

Thus, if the density of each electrode becomes low, the active material and the conductive material do not contact efficiently. As a result, the equivalent series resistance (ESR) increases and thus capacitance decreases. In this case, if a relative content of the conductive material is heightened in order to reduce the equivalent series resistance (ESR), resistance may be lowered. However, since an amount of an electric double layer to be formed is small due to a low surface area value (not more than 1000 m²/g) of a general conductive material, the EDLC capacitor has low capacitance of 10 F/g or less.

In contrast, if a content of the active material such as the activated carbon powder or activated carbon nanofiber is heightened, initial capacitance may increase up to 300 F/g due to the high specific surface area (not more than 3000 m²/g). However, a content of the conductive material is lowered and thus an electrical conductivity is reduced. As a result, capacitance is greatly reduced at a fast scanning speed of 500 mV/s or at a high current value of 100 mA/s.

In addition, if a carbon material having particles of similar shape or size is used, spacing between the entire particles cannot be sufficiently filled to accordingly cause a filling density to be significantly lowered.

### DISCLOSURE

### [Technical Problem]

To solve the above problems or defects, it is an object of the present invention to provide a high-density supercapacitor electrode and its manufacturing method that uses a mixture of carbon materials whose size and shape differ from each other to thereby increase an electrode filling density and to thus secure high capacitance or high power together with low equivalent series resistance (ESR).

### [Technical Solution]

To accomplish the above and other objects of the present invention, according to an aspect of the present invention, there is provided a supercapacitor electrode that is coupled on one side or both sides of a collector, the supercapacitor electrode consisting of a carbon material that forms an electric double layer, wherein the carbon material consists of: a powder-shaped electrode active material; a powder-shaped conductive material; and a fibrous carbon material of a aspect ratio of 3-33.

Preferably but not necessarily, the carbon material consists of: the fibrous carbon material of 1-10 wt %; the powder-shaped electrode active material of 71-81 wt %; and the powder-shaped conductive material of 5-15 wt %, and the carbon material further consists of: a binder of 5-12 wt %.

Preferably but not necessarily, the fibrous carbon material is at least one selected from the group consisting of carbon nanofiber (CNF) of 300-1000 nm in diameter and an activated carbon nanofiber (ACNF), the powder-shaped electrode active material is activated carbon powder (ACP) having an average particle diameter of 10-30 μm, and the powder-shaped conductive material has an average particle diameter of 3-7 nm, and is at least one selected from the group consisting of carbon black (CB), graphite, vapor grown carbon fiber (VGCF), and carbon aerogel.

According to another aspect of the present invention, there is also provided a method of manufacturing a supercapacitor electrode, the supercapacitor electrode manufacturing method comprising the steps of: electrospinning a polymer for carbonization to thus obtain a fibrous carbon material of a aspect ratio of 3-33; mixing the fibrous carbon material with activated carbon powder (ACP), a powder-shaped conductive material and a binder in a three-dimensional stirrer to thereby obtain an electrode material slurry; performing a vacuum deaeration process in order to remove dissolved oxygen or air bubbles from the slurry; coating the slurry having undergone the vacuum deaeration process on a collector using a coating device, to then perform heating and drying; and roll-pressing the dried electrode material slurry in order to improve a contact characteristic between the electrode material and the collector.

Preferably but not necessarily, the fibrous carbon material is at least one selected from the group consisting of carbon nanofiber (CNF) and activated carbon nanofiber (ACNF).

Preferably but not necessarily, the fibrous carbon material has a diameter of 300-1000 nm, the activated carbon powder has an average particle diameter of 5-30 ,μm, and the conductive material has an average diameter of 3-7 nm.

Preferably but not necessarily, the fibrous carbon material of 1-10 wt %, the activated carbon powder of 71-81 wt %, the powder-shaped conductive material of 5-15 wt %, and the binder of 5-12 wt % are employed.

Preferably but not necessarily, the powder-shaped conductive material is at least one selected from the group consisting of carbon black (CB), graphite, vapor grown carbon fiber (VGCF), and carbon aerogel.

Preferably but not necessarily, the polymer for carbonization is at least one selected from the group consisting of polyvinylacetate (PVAc), polyacrylonitrile, polyimide (PI), polyvinylidene fluoride (PVdF), rayon, and pitch.

### [Advantageous Effects]

As described above, the present invention employs a slurry as an electrode material, in which the slurry is obtained by mixing a fibrous carbon material with powder-shaped carbon materials whose sizes differ from each other. In this case, carbon nanofiber (CNF) or activated carbon nanofiber (ACNF) are formed in a medium size between activated carbon powder (ACP) and a conductive material so as to play a role of a lubricant between particles during roll-pressing, to thereby enable an electrode material to have a high density.

The supercapacitor electrode having the above-described electrode material can be implemented into a high-capacitance or high-power supercapacitor together with low equivalent series resistance.

### DESCRIPTION OF DRAWINGS

FIG. 1 shows a photograph illustrating activated carbon nanofiber (ACNF) that is used for a supercapacitor electrode according to the present invention.

FIG. 2 shows a photograph illustrating spherical activated carbon powder (ACP) that is used for a supercapacitor electrode according to the present invention.

FIG. 3 shows a photograph illustrating carbon black (CB) made of spherical nanoparticles that is used for a supercapacitor electrode according to the present invention.

FIG. 4 shows a photograph illustrating a state of smashing the activated carbon nanofiber (ACNF) and controlling the length.

FIG. 5 shows a photograph illustrating an electrode material that is obtained by mixing activated carbon nanofiber (ACNF), activated carbon powder (ACP) and carbon black (CB).

### BEST MODE

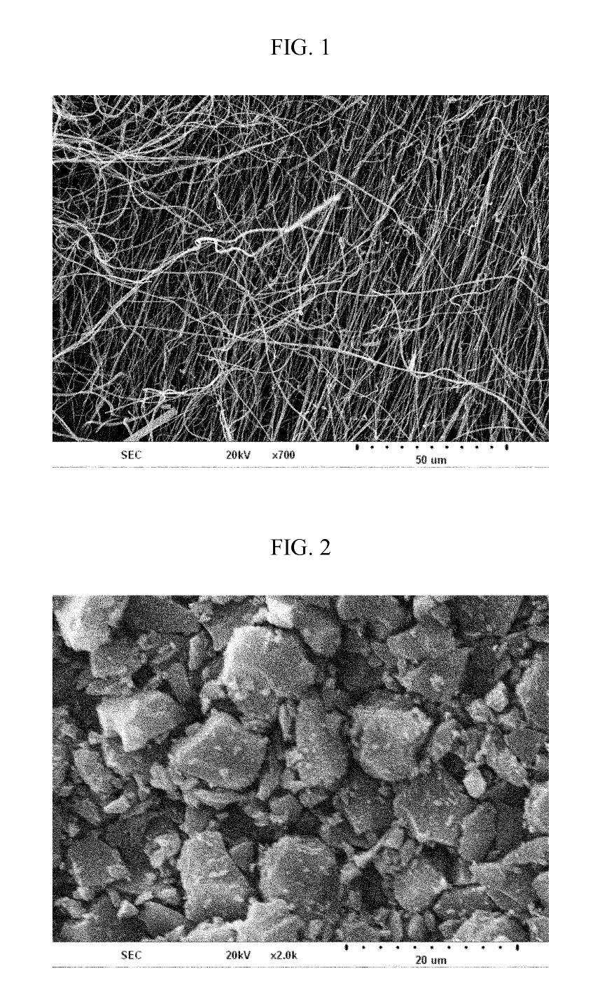

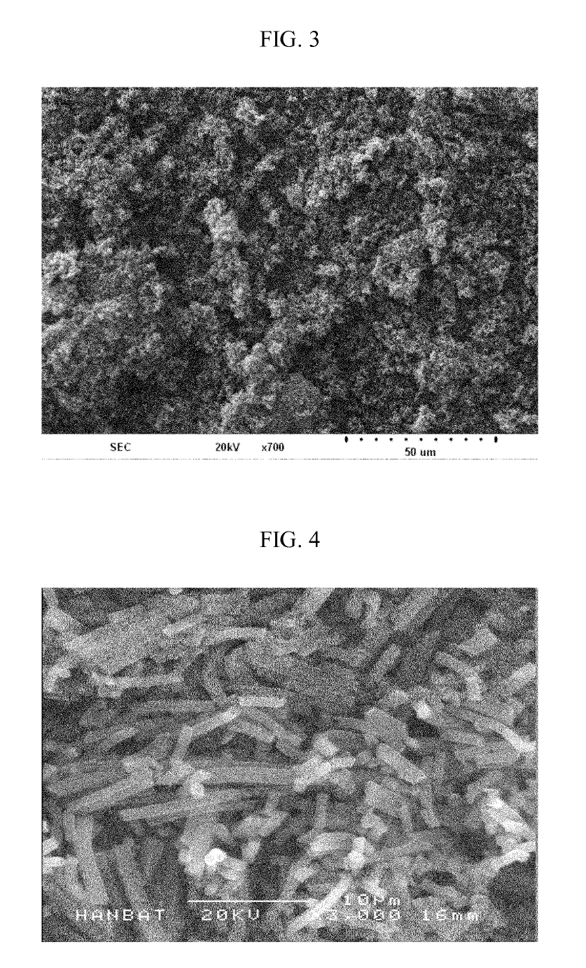

A high-power supercapacitor electrode according to the invention employs carbon nanofiber (CNF) that is manufactured by an electrospinning technique preferably and formed in a fibrous shape through stabilization and carbonization processes and has a diameter of 300-1000 nm and a length of 3-10 μm, and/or activated carbon nanofiber (ACNF) that is formed by activating carbon nanofiber (CNF) to thus increase a specific surface area (see FIG. 1), and activated carbon powder (ACP) having a size of spherical or rectangular powder-shaped particles of about 10-30 μm (see FIG. 2), as a supercapacitor active material. Here, in order to give a conductivity to the supercapacitor active material, a spherical or plate-type powder-shaped conductive material of 3-7 nm in size, that is obtained for example by mixing carbon black (CB) (see FIG. 3) or graphite with a binder at a certain ratio, is cast on the collector through a casting process.

Considering carbon nanofiber (CNF) and activated carbon nanofiber (ACNF) that are used in the present invention have a aspect ratio (or a length to diameter ratio) of 3-33, the carbon nanofiber (CNF) and the activated carbon nanofiber (ACNF) become powder in shape if length thereof is less than 3 μm (when a aspect ratio is 3). As a result, it is difficult for the carbon nanofiber (CNF) and the activated carbon nanofiber (ACNF) to form an efficient point-to-line conduction structure relationship with activated carbon powder (ACP). However, in the case that length of the carbon nanofiber (CNF) and the activated carbon nanofiber (ACNF) exceeds 10 μm (when a aspect ratio is 33), the length of the fiber is too long. Accordingly, poor dispersibility into a slurry phase may be caused.

In addition, activated carbon powder (ACP) having a particle size of several tens of micrometers (μm) of powder that functions as an active material and a conductive material having a particle size of several nanometers (nm) of powder, have been used in the present invention, to thereby have maximized a filling effect.

To this end, according to the inventors' experimental results, it is desirable to have the activated carbon powder (ACP) of 10-30 μm long and the conductive material of 3-7 nm in size, considering diameters of the carbon nanofiber (CNF) or activated carbon nanofiber (ACNF) that are fibrous carbon materials.

Meanwhile, a content of a carbon material constituting the supercapacitor electrode according to the present invention is 88-95 wt % based on the total electrode material, and the rest is 5-12 wt % as a binder. Among the carbon materials, it is preferable that a content of a fibrous carbon material, for example, carbon nanofiber (CNF) or activated carbon nanofiber (ACNF) is 1-10 wt %, a content of electrode active material powder, for example, activated carbon powder (ACP) is 71-81 wt %, a content of powder-shaped conductive material, for example, carbon black is 5-15 wt %.

The carbon nanofiber (CNF) that is added as the fibrous carbon material has an excellent electrical conductivity, to thus play a role of reducing resistance, and simultaneously has a nanometer scale in diameter to thus widen a specific surface area and to play a role of increasing capacitance of electrodes. In addition, the carbon nanofiber (CNF) has a micrometer scale in length, to thus play a role of a bridge between materials constituting electrodes and to thereby improve a binding strength.

The carbon nanofiber (CNF) that is used as the fibrous carbon material is manufactured by electrospinning a polymer for carbonization, for example, into a non-woven cloth to then undergo stabilization and carbonization processes. More specifically, the stabilization process is performed under an air atmosphere at 300° C. and the carbonization process is performed under a vacuum atmosphere or an inert gas atmosphere at 950° C. Then, a grinding process is performed to thus obtain the carbon nanofiber (CNF).

The polymer for carbonization may be at least one selected from the group consisting of polyvinylacetate (PVAc), polyacrylonitrile (PAN), polyimide (PI), polyvinylidene fluoride (PVdF), rayon, and pitch, as a polymer material that can be electrospinned, preferably maintained as a textile shape.

For example, polyacrylonitrile (PAN) is dissolved in a solvent such as di-methylformamide (DMF) or di-methylacetamide (DMAc), and one or more carbon materials (for example, activated carbon powder (ACP), carbon black, etc.) are dispersed in the above solvent to then be mixed with a binder. Then, the mixture obtained is directly spinned on a substrate to be used as an electrode of a capacitor (for example, an electrospinning method, a melt spinning method, or a melt blown spinning method), to then obtain the carbon nanofiber (CNF) through stabilization and carbonization processes.

In order to maximize the specific surface area of the carbon nanofiber (CNF) to thus reveal optimal capacitance, it is more preferable to add activated carbon nanofiber (ACNF) as a fibrous carbon material in which the activated carbon nanofiber (ACNF) is obtained by activating the obtained carbon nanofiber (CNF). Here, the activated carbon nanofiber (ACNF) is re-activated to reveal its own capacitance, has a electrical conductivity of 10⁻³ Ω·cm or so, and has a fibrous structure. Accordingly, the re-activated activated carbon nanofiber (ACNF) makes a point-to-line conduction structure relationship with other powder-shaped carbon materials, to thereby play a role of a conductive material as well as a binder.

It is preferable to add the fibrous carbon material such as the carbon nanofiber (CNF) or activated carbon nanofiber (ACNF) as an amount of addition of 1-10 wt %. However, if the fibrous carbon material is added by less than 1 wt %, it is difficult to substantially expect an additive effect. Meanwhile, if the fibrous carbon material is added by more than 10 wt %, a content of activated carbon powder (ACP) that is a high-capacitive active material becomes small to thereby reduce capacitance and decrease a dispersion performance in a slurry.

It is preferable that a content of the conductive material is 5-15 wt %. If a content of the conductive material is less than 5 wt %, resistance becomes large. If a content of the conductive material exceeds 15 wt %, a content of activated carbon powder (ACP) that is an inherent active material becomes small to thereby reduce capacitance.

The above-described carbon nanofiber (CNF) or activated carbon nanofiber (ACNF) is added between the activated carbon powder (ACP) and the conductive material such as carbon black (CB) to thereby add a conduction structure relationship between a powder-shaped point and a fibrous line to a point-to-point conduction structure relationship, and to thus improve conductivity.

In this case, a collector is made of one selected from the group consisting of a metal foil or metal foam made of a metallic material, a graphite plate, carbon foam, a polymer film coated with the metallic material thereon, or glass coated with a particular material, in which the metallic material is one selected from the group consisting of Au, Pt, Ti, Cu, Ni or Al that does not involve an electrode reaction, that is electrochemically stable, and that has an excellent electrical conductivity. Considering a manufacturing process and cost, it is preferable to use a Cu or Al foil.

In the case of using a metal foil such as a titanium foil, an aluminum foil, and a nickel foil, the thickness thereof is set approximately 20-30 μm.

In addition, it is preferable that the collector has a fine uneven surface considering an efficient contact with an electrode material to be coated on the surface thereof Moreover, a slurry mixture is preferably cast on both surfaces of the collector other than one surface thereof, in the case that an electrode is formed of a stack type in order to manufacture a capacitor in a cylindrical or pouch type.

Meanwhile, in a process of manufacturing a slurry for casting a mixture containing carbon nanofiber (CNF), activated carbon nanofiber (ACNF), activated carbon powder (ACP) and a conductive material, a dispersing process and a grinding process are very important to determine a degree of a high density of an electrode due to differences from the respective carbon materials in shape and size. In this case, the grinding process proceeds in a dry or wet type depending on the nature of the carbon material, using a ball mill or a three-dimensional Z-mill.

Subsequently, the carbon nanofiber (CNF) or activated carbon nanofiber (ACNF) is ground into a desired size (see FIG. 4) and, if required, activated carbon powder (ACP) and the conductive material are also ground into a desired size, to then undergo a dispersion process. Thereafter, these mixed carbon materials are mixed together with a binder and a solvent.

Thus, carbon nanofiber (CNF) or activated carbon nanofiber (ACNF) that is made in a fibrous shape of several micrometers (μm) in length and several hundreds nanometers (nm) in diameter is mixed with activated carbon powder (ACP) of several tens nanometers (nm) in size and a conductive material of several nanometers (nm) in size. In this case, a filling effect increases in comparison with the case where each carbon material is used as a single filler, to thereby heighten a filling density of the electrode material.

Meanwhile, in addition to the carbon nanofiber (CNF) or activated carbon nanofiber (ACNF), activated carbon powder (ACP), carbon black being the conductive material, as the electrode materials of the supercapacitor according to the present invention, vapor grown carbon fiber (VGCF), graphite, carbon nanotube (CNT), and carbon aerogel may be used as the electrode materials. In this case, it is desirable that the vapor grown carbon fiber (VGCF) should be used as a conductive material by making the remainder group on the surface of the vapor grown carbon fiber (VGCF) into hydrophilic groups, rather than the case where the vapor grown carbon fiber (VGCF) is directly used as an active material. In addition, it is desirable that the graphite and carbon nanotube should be also mixed with the vapor grown carbon fiber (VGCF) to then be used as an active material as well as a conductive material, using its own electric conductivity, rather than the case that the graphite and carbon nanotube is used as a single active material in order to manufacture an electrode. It is further desirable to use activated carbon powder (ACP), graphite, and the like having different shapes and different sizes from each other, than to use a mixture of the carbon nanofiber (CNF), the activated carbon nanofiber (ACNF), and the vapor grown carbon fiber (VGCF) having an identical fiber shape, in view of enhancement of the density of the electrode.

In addition, the present invention uses a binder in order to enhance a contact characteristic between the electrode material and the collector, or between the electrode materials. There are carboxy methyl cellulose (CMC), polyvinylidenefluoride (PVdF-co-HFP; polyvinylidene fluoride-co-hexa fluoropropylene) group, polytetrafluoroethylene (PTFE; polytetra fluoroethylene in fluorine group) powder or emulsion, and styrene butadiene rubber (SBR) of rubber group, etc., as kinds of the binder. The binder is preferably used depending on type of a solvent.

Here, it is preferable to use a content of a binder of 5-12 wt % that is the minimum amount that can maintain physical characteristics of the electrode material. In other words, if a content of the binder is less than 5 wt %, the conductive material and the electrode material such as the active material are not so sufficiently cross-linked that there may be a problem of causing secession of the electrode material due to occurrence of resistance and reduction of physical properties. If a content of the binder exceeds 12 wt %, an electrode sheet embrittles to thus increase viscosity and decrease ease of operation. In addition, since the binder is non-conductive, unlike the carbon materials that are used for electrodes, the more the content may increase, the more the resistance may increase.

The supercapacitor electrode that is manufactured through the above-described process according to the present invention is manufactured into a pouch-type thin film or a can-type cylinder shape, to thereby manufacture medium-scale capacitors, depending on coverage of applications. Further, the supercapacitor electrode is designed into a modular design, to thereby manufacture large-scale capacitors.

### EXAMPLE

First, activated carbon nanofiber (ACNF) of a specific surface area 1800 m²/g that is obtained by electrospinning polyacrylonitrile (PAN) to then undergo stabilization and carbonization processes, activated carbon powder (ACP), carbon black (CB) being a conductive material, and carboxy methyl cellulose (CMC) or styrene butadiene rubber (SBR) being a binder are weighed and prepared at a ratio indicated in Table 1, respectively, and are mixed in a three-dimensional stirrer (Kurabo company; KK-100) using distilled water as a solvent, to thus get a slurry. Here, the carbon materials whose particles differ in size and the granular carboxy methyl cellulose (CMC) are firstly mixed, and then are mixed again with the liquid-phase styrene butadiene rubber (SBR) and the distilled water. Here, the activated carbon powder (ACP) is a product of Power carbon technology company, the conductive material is a product “Super-P” of Timcal company, the carboxy methyl cellulose (CMC) being the binder is a product “NA-L” of Nichirin company, and the styrene butadiene rubber (SBR) being the binder is a product “BM-400B” of Zeon company.

In addition, the activated carbon nanofiber (ACNF) with an average diameter of 500 nm, the active carbon powder (ACP) with an average particle diameter of 10 μm, and the conductive material with an average particle diameter of 5 nm were used.

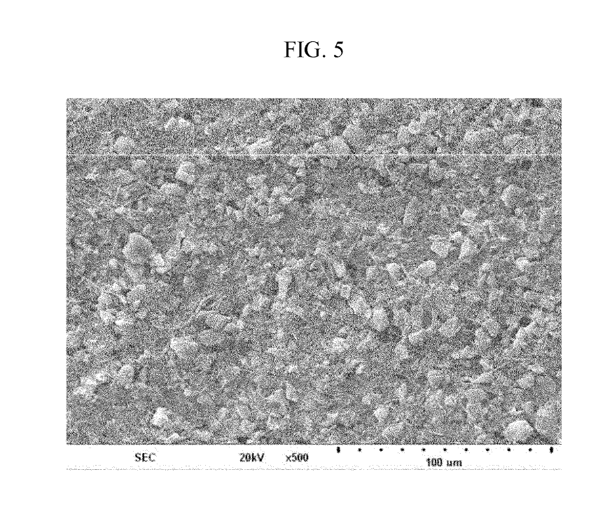

As shown in FIG. 5, the slurry is made in a high density form in a manner that pores between the mixed carbon materials are not almost visible.

Subsequently, a vacuum deaeration process is undergone in order to remove dissolved oxygen or air bubbles in the slurry that is prepared through the above-described process.

The slurry having finished the deaeration process is coated with a thickness of 50-80 μm on a aluminum collector (etched-Al of JCC company) of 20 μm thick using a predetermined coating device.

Subsequently, in order to improve a contact characteristic between the electrode material and the collector, a roll-pressing process proceeds, to thus obtain a high-density supercapacitor electrode. In this case, an upper roll is not heated and a lower roll is heated at 70° C.

In order to confirm electrical characteristics of the electrode materials obtained through the above-described process, an electrode on which the electrode material has been coated was divided into and cut as a cathode and an anode, to thereby have obtained a can-type electrode of D08L20. In this case, tetra ethyl ammonium tetrafluoro borate/aceto nitrile (TEABF₄/ACN) of 1 M were used as an electrolyte. An estimation of the electrical characteristics of the electrode materials was performed at a range of voltage of 0.0-2.7 V using a charging and discharging unit (Human instrument company) and the estimation results are illustrated in Table 1.

TABLE 1

| | Density | Density | | | | | | |
|---|---|---|---|---|---|---|---|---|
| | (before | (after | | | | | Conductive | |
| | rolling) | rolling) | Capacitance | ESR | ACNF | ACP | material | Binder |
| | (g/cm3) | (g/cm3) | (F) | (mΩ) | (wt %) | (wt %) | (wt %) | (wt %) |
| Comparative | 0.532 | 0.559 | 2.82 | 45.4 | — | 81 | 14 | 5 |
| example | | | | | | | | |
| Example 1 | 0.520 | 0.562 | 2.88 | 40.8 | 1 | 80 | 14 | 5 |
| Example 2 | 0.453 | 0.599 | 3.21 | 33.7 | 3 | 78 | 14 | 5 |
| Example 3 | 0.490 | 0.594 | 2.92 | 36.4 | 5 | 76 | 14 | 5 |
| Example 4 | 0.528 | 0.582 | 2.71 | 41.1 | 10 | 71 | 14 | 5 |

As shown in Table 1, according to the present invention, if a content of activated carbon nanofiber (ACNF) increases from 1 wt % to 3 wt %, an equivalent series resistance (ESR) of a capacitor decreases and capacitance increases. Unlike a comparative example that constitutes an electrode using only the activated carbon powder (ACP), conductive material and binder, it is predicted that this fact was due to because part of the activated carbon powder (ACP) was replaced with the activated carbon nanofiber (ACNF), to thereby have added a point-to-line conduction structure relationship to a point-to-point conduction structure relationship.

Meanwhile, as illustrated in Examples 3 and 4, if a content of the activated carbon nanofiber (ACNF) increases from 5 wt % to 10 wt %, the equivalent series resistance (ESR) of the capacitor slightly increases and capacitance tends to decrease more or less. The reason is because a relative content of the activated carbon powder (ACP) being a high capacitive active material decreases and dispersibility into a slurry form is reduced, to thus make it difficult to maintain a uniform electrode, if an amount of the activated carbon nanofiber (ACNF) increases.

However, it needs to not that values of the equivalent series resistance of the Examples 3 and 4 are still low compared to that of the comparative example.

In addition, since the density of the activated carbon nanofiber (ACNF) itself, is smaller than that of the density of the activated carbon powder (ACP), the densities as shown in Examples 3 and 4 again show the tendency to decrease if a content of the activated carbon nanofiber (ACNF) exceeds a certain amount of the content. Furthermore, since the activated carbon nanofiber (ACNF) is fibrous, a spring-back phenomenon may occur. The spring-back phenomenon means that the activated carbon nanofiber (ACNF) is re-bulged if the activated carbon nanofiber (ACNF) has been depressed and then released back. The spring-back phenomenon is regarded as a cause of reducing the density. Contribution to capacitance is greater in the activated carbon powder (ACP) than in the activated carbon nanofiber (ACNF). Accordingly, it can be predicted that capacitance tends to decrease slightly as a content of the activated carbon nanofiber (ACNF) increases. However, even in this case, it needs to note that capacitance of Example 3 is still maintained to have a higher value than that of the comparative example. In the case of Example 4, capacitance is 2.71 that is lower than that of the comparative example. However, since the equivalent series resistance of Example 4 is still maintained to have a lower than that of the comparative example, the electrode made from Example 4 can be usefully applied for an electrode material requiring a high power particularly.

From the results, it was confirmed to represent the highest capacity, the lowest resistance, and the highest density, when a content of the activated carbon nanofiber (ACNF) is 3% (Example 2).

Finally, as shown in Example 2, it can be seen that density as well as capacitance increases if the activated carbon nanofiber (ACNF) of the fibrous polyacrylonitrile (PAN) group having the low density is mixed with the activated carbon powder (ACP).

### INDUSTRIAL APPLICABILITY

The present invention can be applied to a high-density supercapacitor electrode, for example, an electric double layer capacitor (EDLC) electrode or a pseudo capacitor electrode that uses a mixture of carbon materials whose sizes differ from each other and fibrous carbon materials, to thereby increase an electrode filling density and to thus secure high capacitance or high power together with low equivalent series resistance (ESR). As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

1. A supercapacitor electrode that is coupled on one side or both sides of a collector, the supercapacitor electrode consisting of a carbon material that forms an electric double layer, wherein the carbon material consists of:
a powder-shaped electrode active material;
a powder-shaped conductive material; and
a fibrous carbon material of a aspect ratio of 3-33.

2. The supercapacitor electrode according to claim 1, wherein the carbon material consists of:
the fibrous carbon material of 1-10 wt %;
the powder-shaped electrode active material of 71-81 wt %; and
the powder-shaped conductive material of 5-15 wt %, and wherein the carbon material further consists of: a binder of 5-12 wt %.

3. The supercapacitor electrode according claim 1, wherein the fibrous carbon material is at least one selected from the group consisting of carbon nanofiber (CNF) of 300-1000 nm in diameter and an activated carbon nano fiber (ACNF) of 300-1000 nm in diameter.

4. The supercapacitor electrode according to claim 1, wherein the powder-shaped electrode active material is activated carbon powder (ACP) having an average particle diameter of 10-30 μm.

5. The supercapacitor electrode according to claim 1, wherein the powder-shaped conductive material has an average particle diameter of 3-7 nm, and is at least one selected from the group consisting of carbon black (CB), graphite, vapor grown carbon fiber (VGCF), and carbon aerogel.

6. A method of manufacturing a supercapacitor electrode, the supercapacitor electrode manufacturing method comprising the steps of:
electrospinning a polymer for carbonization to thus obtain a fibrous carbon material of a aspect ratio of 3-33;
mixing the fibrous carbon material with activated carbon powder (ACP), a powder-shaped conductive material and a binder in a three-dimensional stirrer to thereby obtain an electrode material slurry;
performing a vacuum deaeration process in order to remove dissolved oxygen or air bubbles from the slurry;
coating the slurry having undergone the vacuum deaeration process on a collector using a coating device, to then perform heating and drying; and
roll-pressing the dried electrode material slurry in order to improve a contact characteristic between the electrode material and the collector.

7. The supercapacitor electrode manufacturing method of claim 6, wherein the fibrous carbon material is at least one selected from the group consisting of carbon nanofiber (CNF) and activated carbon nanofiber (ACNF).

8. The supercapacitor electrode manufacturing method of claim 6, wherein the fibrous carbon material has a diameter of 300-1000 nm, the activated carbon powder has an average particle diameter of 5-30 μm, and the conductive material has an average diameter of 3-7 nm.

9. The supercapacitor electrode manufacturing method of claim 6, wherein the fibrous carbon material of 1-10 wt %, the activated carbon powder of 71-81 wt %, the powder-shaped conductive material of 5-15 wt %, and the binder of 5-12 wt % are employed.

10. The supercapacitor electrode manufacturing method of claim 6, wherein the powder-shaped conductive material is at least one selected from the group consisting of carbon black (CB), graphite, vapor grown carbon fiber (VGCF), and carbon aerogel.

11. The supercapacitor electrode manufacturing method of claim 6, wherein the polymer for carbonization is at least one selected from the group consisting of polyvinylacetate (PVAc), polyacrylonitrile, polyimide (PI), polyvinylidene fluoride (PVdF), rayon, and pitch.
